(19) United States
(12) Patent Application Publication
(10) Pub. No.: US 2013/0106293 A1
(43) Pub. Date: May 2, 2013

(54) Auto Switch Dual Power Lights

(71) Applicant: Saudi Arabian Oil Company, Dhahran (SA)

(72) Inventor: Mohammed N. Al-Khamis, Ras Tanura (SA)

(73) Assignee: Saudi Arabian Oil Company, Dhahran (SA)

(21) Appl. No.: 13/665,176

(22) Filed: Oct. 31, 2012

Related U.S. Application Data
(60) Provisional application No. 61/553,531, filed on Oct. 31, 2011.

(51) Int. Cl. H05B 37/02

(52) U.S. Cl. 315/153

(57) ABSTRACT

An illumination system monitors light output of a solar powered light source and controls power to an alternate light source having a secondary power source. The solar powered light source is an array of light emitting diodes. The alternate light source is in the form of fluorescent lights. A sensor photocell is positioned to sense illumination output from the solar powered array. A control mechanism senses a signal from the photocell sensor and turns power on and off to the alternate light source according to the light output sensed from the solar powered source.

### CROSS REFERENCE TO RELATED APPLICATIONS

This application claims priority from U.S. Provisional Application No. 61/553,531, filed Oct. 31, 2011. For purposes of United States patent practice, this application incorporates the contents of the Provisional Application by reference in entirety.

### BACKGROUND OF THE INVENTION

1. Field of the Invention

The present invention relates to control of the type of power supplied for illumination in the interior of buildings from LED arrays, powered by solar panels, and from fluorescent lamps, powered by electrical power mains.

2. Description of the Related Art

In order to offset main power consumption, solar panels and other alternate power sources were added to current buildings or incorporated into new building designs. In these systems, solar panels provided higher power output during peak sun hours and lower power output during non-peak hours. This created a problem when the purpose of the power generated. by the solar panels was illumination. The non-peak power output of the solar cells was insufficient to illuminate a given set of lights.

Designs in the industry looked to overcome this problem by the incorporation of batteries into lighting systems. Batteries allowed power to be stored during peak sun hours and used when needed in nonpeak hours. Limitations existed for solar and battery installations. First, the power output during peak hours needed to be divided between the lights in use and the charging of the batteries. This increased the number of solar cells needed in a given installation. Also, initial battery installations created added expense and the batteries needed replacement after a given period of time, A solar and battery installation required extensive control circuitry, providing for a complex and costly installation.

Other designs to overcome this problem involved lighting systems that were powered by either solar panel generated power or a main building power source. One advantage these installations had over solar panel and battery installations was reduced cost of the initial installation. Additionally, these systems still achieved the goal of reducing main power consumption. In this type of installation there existed the problem of when and how to make the transition between the solar panel power source and the main power source. Photocells were used in this area. A sensor such as a photocell detected a certain light level based on the voltage output of the photocell sensor. Photocells have been used in outdoor lighting installations to detect a lighting level existing at dawn or dusk and to control a light based on that signal,

U.S. Published Patent Application No. 2011/0032695 relates to solar powered light assemblies with a connection to main building power. The solar panels powered a rechargeable battery which powered a light emitting diode array, and a main building power source routed to an incandescent bulb. The light assembly sensed outdoor ambient light levels according to one photocell sensor and turned on the rechargeable battery powered light emitting diode array when a pre-determined ambient light level was sensed at dusk. A second photocell sensor sensed the light levels of the light emitting diode array and switched power to the incandescent bulb when the amount of light supplied by the light emitting diode array was lower than a pre-determined minimum level such as when the rechargeable battery was drained of power. This assembly had disadvantages for daytime and indoor lighting installations or installations where a rechargeable battery was not present. One disadvantage of this assembly was that the second photocell directly sensed light output from both light sources in the enclosure. By sensing output from both light sources, once the incandescent bulb had been turned on, the control system sensing the light output of the light emitting diode array was no longer engaged. In this scenario, the incandescent bulb would remain on until dawn or until the light was manually turned off.

U.S. Published Patent Application No. 2009/0224681 related to a hybrid solar powered and grid powered lighting system. This application described a system for switching between solar panel power and grid power or alternatively switching to a combination of solar panel power and grid power for a lighting installation. Specifically this system utilized current measurements of the amount of power generated by the solar panels to determine the amount of grid power that needed to be added for a given lighting installation. Complex circuitry was required to accomplish this, which increased the cost to implement this system.

### SUMMARY OF THE INVENTION

The present invention provides a new and improved illumination system that more efficiently utilizes solar panel power thereby reducing grid power consumption. The illumination system provides lighting for the interior of a building with available solar energy when ambient light permits to reduce usage of electricity from power grids. The illumination system has an illumination array with a plurality of LED lights and a plurality of fluorescent lights. A solar cell panel provides power to the LED lights in the illumination array, and a photocell senses the ambient light level in an interior space of a building. A control mechanism is activated by the photocell to activate the fluorescent lights when the sensed ambient light level is below an established level for utilization of the LED lights for illumination purposes.

### BRIEF DESCRIPTION OF THE DRAWINGS

FIG. 1 is a schematic diagram of an illumination system for lighting an interior space of a building in accordance with the present invention.

FIG. 2 is a schematic diagram illustrating an illumination system in accordance with the present invention.

FIG. 3 is a schematic electrical diagram illustrating a photocell resistor sensor mechanism and switch for the illumination system of FIG. 2.

### DETAILED DESCRIPTION OF THE PREFERRED EMBODIMENTS

The present invention relates to energy saving by automatic illumination control, the illumination from a primary light source powered by solar cell panels and the illumination from a secondary light source powered from electrical power mains. The present invention is particularly adapted for use where the lighting and light sensing both occur in the interior space of a building.

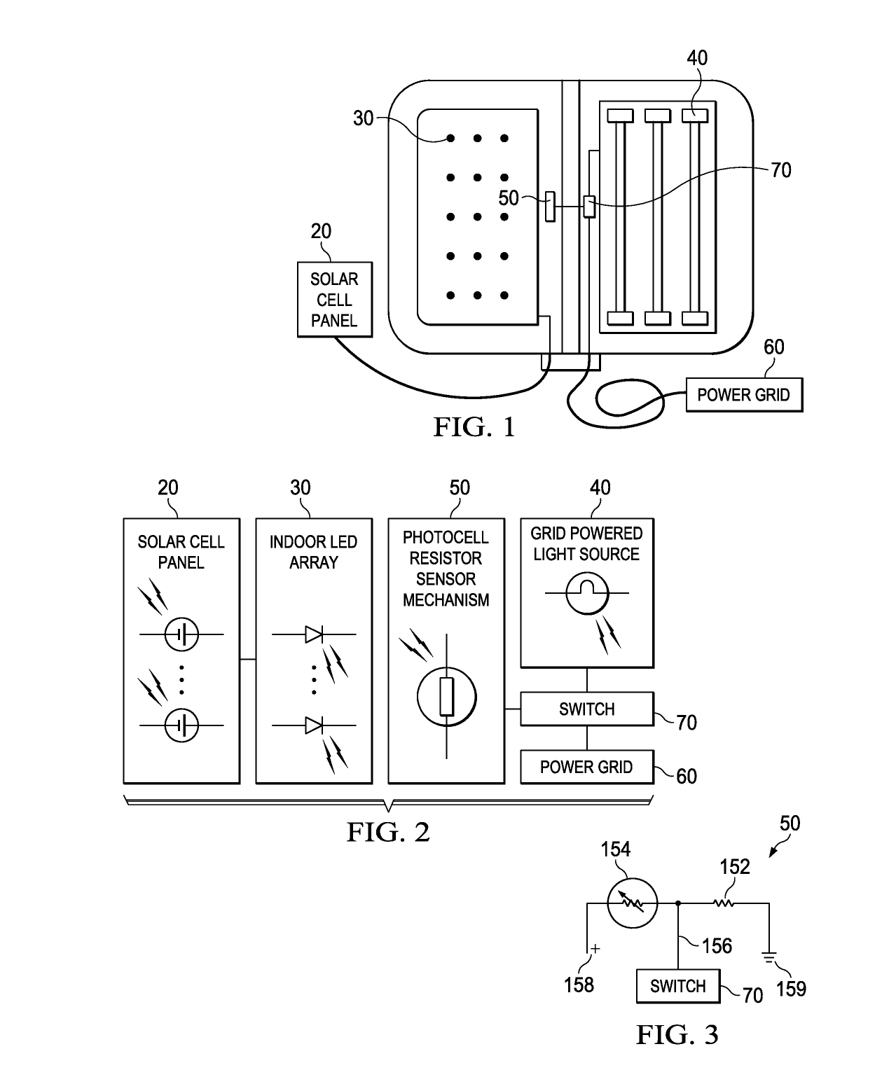

FIG. 1 illustrates an example automatic illumination control system according to the present invention. A primary light source 30 is shown as an array of LED lights powered by a solar cell panel 20. The LED light array provides sufficient illumination for the interior of a building or enclosure when the solar cell panel 20 is receiving incident light in normal sunny conditions. A photocell resistor sensor mechanism 50 monitors the light output from LED lights of the primary light source 30. The photocell resistor sensor mechanism 50 is electrically connected to a switch 70 that controls flow of power from a main electrical power grid 60 to the secondary light source 40 based on the light sensed by the photocell resistor sensor mechanism 50. The secondary light source 40 is powered by a power grid 60. The power grid 60 may receive power from any number of sources. Power sources may include but are not limited to the power provided by a local utility provider or power from onsite generators. It should be understood that other sources of grid power may also be utilized.

The preferred embodiment uses an array of light emitting diodes or LED's 30 for the primary light source and fluorescent lamps as the secondary light source 40. LED arrays can typically provide more light per watt of energy consumed than other available light sources, and this makes the pairing of a solar panel power source and an LED light source advantageous when the goal is reducing grid power consumption.

By comparison, fluorescent bulbs are typically more economical to install than LED arrays and many current building installations already utilize fluorescent bulbs. The present invention may be integrated into current building designs with fluorescent fixtures already installed, or the present invention may be used in new building designs. The fluorescent lamps are preferably energy efficient light sources although others may be used. It should be understood that different light sources for the primary light source other than LED's may also be used. Light sources may include LED, fluorescent, incandescent, or other existing sources of illumination may be used for the primary light source, if desired. Further, the preferred embodiments may utilize outdoor solar panel installations or solar panels installed as partial sunshades at the windows or roof of the building or enclosure being illuminated to reduce heat caused by direct sunlight.

FIG. 2 is a schematic or functional block diagram of the illumination system according to the present invention. The solar cell panel 20 has a plurality of solar cells. The configuration of the solar cell panel may be of any suitable conventional type, according to solar conditions, building construction considerations, peak and average expected power demand, and the like, Additionally, multiple solar cell panels may be used for the solar cell panel 20. The solar cell panel 20 connects to and powers the indoor LED array 30.

The photocell resistor sensor control mechanism 50 includes a photocell resistor that senses the light output of the indoor LED array 30. In a given installation the photocell resistor 154 is located in the building being illuminated in proximity to the LED array 30 such that the photocell resistor 154 senses the ambient illumination level of the primary source 30. When the light output of the LED array 30 rises above an established illumination level, power flow to the secondary light source 40 is blocked by a switch 70. The photocell resistor sensor mechanism 50 permits switch 70 to allow flow of grid power 60 to the secondary or powered light source 40 when the photocell resistor sensor mechanism 50 senses the LED arrays 30 light output is below the established level. Additionally, when the photocell resistor sensor control mechanism 50 senses the LED array 30 has again achieved an illumination level above the established level, the photocell resistor sensor control mechanism 50 causes switch 70 to halt flow from grid power 60 to the secondary light source 40, thereby reducing power consumption off the grid.

FIG. 3 illustrates in further detail the photocell resistor sensor mechanism 50, which includes a photocell resistor 154 of the commercially available type, formed of light sensitive cells. The photocell resistor 154 is connected to a voltage reference level at source 158 and to a resistor 152 which is connected to electrical ground, as indicated at 159. A connection point 156 located between the photocell resistor 154 and the resistor 152 exhibits a voltage level governed by the resistance of the photocell resistor 154, which is in turn dependent on the sensed ambient illumination level in the building. At the desired ambient illumination level, the resistance of the photocell resistor 154 is substantially the same as the resistor 152, and the point 156 thus is at a voltage level which is half the voltage of the voltage source 158.

The cells of the photocell resistor 154 are sensitive to light and exhibit changes in resistance based on the incident light levels sensed, as provided by the primary light sources 30. When the light provided by sources 30 is adequate, the cells of the photocell resistor 154 increase in resistance and in effect the photocell terminals, changing the voltage presented at connection point 156 to switch 70. When the light from sources 30 decreases, the cells of the photocell resistor 154 decrease in resistance, changing the voltage presented at connection point 156 to switch 70. With this capability, the present invention activate the lights of the secondary source 40 when the need is sensed and switches them off again automatically when adequate light is present from the primary light sources 30.

When the illumination from the LED lights 30 on photocell resistor 154 decreases because of dusk, overcast weather, or for other reasons, the resistance of the photocell resistor decreases and voltage at point 156 changes accordingly. The voltage sensitive switch 70 connected at point 156 is set to be sensitive to a voltage level indicative of an unacceptable illumination output from the LED lights 30. Thus, when the voltage at point 156 is not present at the set or established level, the voltage sensitive switch closes 70 and enables power to flow to the secondary light source 40 from the power grid 60.

Conversely, when the illumination from the LED lights 30 on photocell resistor 154 increases because of dawn, the passing of overcast weather, or for other reasons, the resistance of the photocell resistor increases and voltage at point 156 changes accordingly. When the voltage at point 156 meets the set or established level, the voltage sensitive switch 70 opens and power ceases to flow to the secondary light source 40 from the power grid 60.

Thus, with the present invention an lumination system with dual light source systems for illumination purposes is provided. The LED lights of the primary source 30 are operated by the solar cell(s) 20 and the secondary light source 40 receives operating power from power mains of the grid 60. Switching to furnish adequate power for illumination purposes is done automatically when the control mechanism 50 senses low illumination output from the LED lights of the primary source to optimize power consumption. The present invention draws solar power in the amounts that are available from the solar cell panel(s) 20, switching to supplement power for illumination from the power grid only when building lighting needs dictate.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. An illumination system for lighting the interior of a building with available solar energy when ambient light permits to reduce usage of electricity from power grids, comprising:
an lumination array comprising a plurality of LED lights and a plurality of fluorescent lights;
a solar cell panel providing power to the LED lights in the illumination array;
a photocell sensing the ambient light level in an interior space of the building; and
a control mechanism activated by the photocell to activate the fluorescent lights when the sensed ambient light level is below an established level for utilization of the LED lights for illumination purposes.

2. The apparatus according to claim 1, further comprising a plurality of solar cell panels providing power to the LED lights in the illumination array.

3. The apparatus according to claim 1, wherein the control mechanism comprises a voltage sensitive switch.

4. The apparatus according to claim 3, wherein the voltage sensitive switch selectively permits power to flow to the plurality of fluorescent lights.

5. The apparatus according to claim 4, wherein the photocell senses ambient light output from the LED lights; and wherein the voltage sensitive switch is connected to the photocell,

6. The apparatus according to claim 5, wherein a voltage source is connected to the photocell.

7. An illumination system for lighting the interior of a building with available solar energy when ambient light permits to reduce usage of electricity from power grids, comprising:
an illumination array comprising a plurality of first light sources and a plurality of second light sources;
a solar cell panel providing power to the first light sources in the illumination array;
a photocell sensing the ambient light level in an interior space of the building; and
a control mechanism activated by the photocell to activate the second light sources when the sensed ambient light level is below an established level for utilization of the first light sources for illumination purposes.

8. The apparatus according to claim 7, further comprising a plurality of solar cell panels providing power to the plurality of first light sources in the illumination array.

9. The apparatus according to claim 7, wherein the control mechanism comprises a voltage sensitive switch.

10. The apparatus according to claim 9, wherein the voltage sensitive switch selectively permits power to flow to the plurality of second light sources.

11. The apparatus according to claim 10, wherein the photocell senses ambient light output from the plurality of first light sources; and wherein the voltage sensitive switch is connected to the photocell.

12. The apparatus according to claim 11, wherein a voltage source is connected to the photocell.

13. A method of lighting the interior of a building with available solar energy when ambient light permits to reduce usage of electricity from power grids, comprising:
providing power to a first light source with power from a solar cell panel;
sensing, the ambient light level in an interior space of the building;
determining, when the sensed ambient light level is below an established level for utilization of the first light sources for illumination purposes;
activating, power to a second light source with power from a building electricity grid when the sensed ambient light level is below the established level.

14. The method according to claim 13, further comprising:
providing power to the plurality of first light sources in the illumination array with a plurality of solar cell panels.

15. The method according to claim 13, wherein the step of determining is performed by a voltage sensitive switch.

16. The method according to claim 15, wherein the step of activating comprises:
selectively permitting power to flow to the plurality of second light sources in response to the voltage sensitive switch.

17. The method according to claim 16, further comprising:
sensing light output from the plurality of first light sources by the photocell.
